(19) United States
(12) Patent Application Publication
(10) Pub. No.: US 2004/0026881 A1
(43) Pub. Date: Feb. 12, 2004

(54) Wearable sled

(76) Inventor: Bernard Touchette, Lachenaie (CA)

Correspondence Address: Bernard Touchette, 820, Boisbouscache, Lachenaie, QC, J6W 5H2, CA

(21) Appl. No.: 10/637,678

(22) Filed: Aug. 11, 2003

(30) Foreign Application Priority Data
Aug. 9, 2002 (GB) 0218539.5

(51) Int. Cl. B62B 9/04

(52) U.S. Cl. 280/20; 280/18

(57) ABSTRACT

A wearable sled includes a sled body made out of a substantially thin and flexible polymeric resin. The sled body has a sliding surface for slidably contacting a slippery slope and a user contacting surface for contacting the user body. A pair of shoulder straps allows attachment of the sled body adjacent a first end thereof to the shoulders of the user. A pair of foot straps allows attachment of the sled body adjacent a second end thereof to the feet of the user. The sled body is configured and sized for extending substantially across the width of the user body from the base of the neck region to the feet of the user when the sled body is in a deployed configuration with the shoulder and foot releasable attachment straps attached to the user body.

### FIELD OF THE INVENTION

The present invention relates to the general field of recreational devices and is particularly concerned with a wearable sled.

### BACKGROUND OF THE INVENTION

Most parents are faced with the common problem of finding suitable entertainment for children and young adults. Because of an inherent need to release pent-up energy and to fight boredom, some children often time engage in potentially destructive pursuits that are not particularly malicious but are sometimes related to this need to fight boredom.

Furthermore, some parents all too often find that their children are engaged in so-called sedentary activities such as playing video games, watching television or the like particularly during periods of inclement weather. Although such activities are relatively harmless, they nevertheless result in little physical activity and exertion and, hence, are not conductive to promoting good habits and physical health.

One popular activity for children and adults alike that may lead children and young adults to lead more active life including healthy outdoor activities is to slide on hills covered with snow. The traditional ways to enjoy downhill sliding include sleds, skis, toboggans and makeshift sleds using boxes with durable bottoms or the like.

Sliding downhill provides a thrill that has been sought for and appreciated for many years, perhaps even many centuries. The thrill of conventional sledding however is sometimes tempered by the fact that the slider is tethered to cumbersome sled devices.

Once the slider using conventional sleds reaches the bottom of a hill, he or she must drag the oftentimes cumbersome sled back up the hill for another run. The uphill climb is often considered the most strenuous part of the activity. This uphill climb becomes more torturous when the slider has to carry a sled which is bulky, heavy and reduces the mobility of the user. As a result, often it is the parents or an adult who carry this duty for a child.

For example, when a relatively large sledding device such as a toboggan is being used it may even require the efforts of at least two people to drag the toboggan back to the top of the hill. Even when a smaller sledding device is used, ascending an ice covered or particularly steep hill, may prove to be particularly difficult since often times, carrying the sled requires the use of at least one hand.

The use of one hand impairs the balance of the user potentially leading to his or her fall.

Another disadvantage associated with some conventional sledding devices is that, in the event that the slider falls or otherwise unintentionally lets go of the sledding device during ascension of a hill or falls off the sledding device during the actual sliding use, the sled becomes a run away sled that is free to run down the hill unattended. Unattended sleds running down a hill may gain considerable speed and pose a significant safety hazards to other people standing by or to other sliders.

Traditionally, some recreational toy sleds for children included a pair of metal snow engaging runners that extended from beneath a generally planar top deck. The top deck was designed to receive a rider sitting or laying thereon. Often times, such a sled was provided with a steering mechanism incorporating a linkage attached to the front portion of the runners. The linkage was operated by twisting or bending the front portion of the runners in the desired direction of travel.

Nowadays, a great variety of winter sports items are available for sliding downhill. These devices include different types of sleds, bob-sleds, so-called ski “bobs”, snow “wings” and the like. Another problem associated with these newer types of sledding devices relates to their lack of steerability. The possibility of bodily injury, whether significant or insignificant in nature, resulting from this lack of maneuverability, can never be precluded.

For example, the so-called snow “wings” typically includes a flat saucer-like dish on which the user rests, as the device is typically made out of a polymeric resin, slides downwardly. This type of device is exceedingly difficult if not impossible to guide with any certainty.

Furthermore, the user may also inadvertently roll or fall off the dished device that is very shallow. In such instances, the device could continue to descend alone with the hereinabove mentioned potential dangers associated with hitting a bystander and, also, the user might be stranded on the snow covered hill.

Other types of popular devices also suffer from the same drawbacks. For example, recently, sleds have been constructed as a unitary polymeric structure defined as a “mat”. However, the slider very often slides off the mat. This type of mat lacks steering capabilities. Such structures are however advantageous in that they are relatively inexpensive, light weight and durable. Additionally, they are not subject to rusting and loosening of parts of fasteners which frequently occurred with more traditional sleds. Accordingly, there exists a need for an improved sled offering some of the advantages of prior art “mat”-type sleds without their inherent drawbacks.

### SUMMARY OF THE INVENTION

It is a general object of the present invention to provide an improved sled.

In accordance with the present invention, there is provided a sled for allowing an intended user to slide on a slippery surface, the user having a user body defining a trunk, the trunk having a trunk upper end including a trapezius region, a trunk front side including a pectoral region and an abdominal region, a trunk rear side including a scapulae region, a lumbar region and a buttocks region, the user body also having a pair of arms connected to the trunk by a corresponding pair of shoulders, the arms and the trunk together defining a corresponding pair of armpits, the user body further having a head connected to the trunk by a neck, a pair of legs connected to the trunk by a corresponding pair of hips and a pair of feet connected to the legs by a corresponding pair of feet; the sled comprising: a sled body made out of a substantially thin and flexible sled body material, the sled body having a substantially elongated configuration defining a longitudinal axis, a sled first longitudinal end, an opposed sled second longitudinal end and a pair of substantially longitudinally extending body lateral edges; the sled body having a sliding surface for slidably contacting the slippery surface and a user contacting surface for contacting the user body; a shoulder releasable attachment means extending from the sled body substantially adjacent the sled first longitudinal end for releasably attaching the sled body to the user body substantially adjacent the shoulders thereof; an foot releasable attachment means extending from the sled body substantially adjacent the sled second longitudinal end for releasably attaching the sled body to the user body substantially adjacent the feet thereof; the sled body being configured and sized for extending substantially across the width of the user body from the base of the neck region to the feet when the sled body is in a deployed configuration with the shoulder and foot releasable attachment means attached to the user body.

Typically, the sled body is made out of a substantially flat strip of sled body material. Conveniently, the sled body material is a polymeric resin. Typically, the polymeric resin includes high density polyethylene. Conveniently, the strip has a strip thickness of approximately 40 thousands of an inch. Typically, the sled body resiliently curls up at least partially into a rolled configuration when in a relaxed state deprived of external forces exerted thereon other then gravity.

Conveniently, the sled body is configured, sized and made out of a material such that the sled body curls up into a roll when the sled body is attached to the user body by the shoulder releasable attachment means; the foot releasable attachment means is unattached to the user body, leaving the sled second longitudinal end free to curl up towards the sled first longitudinal end, and; the user body is in a substantially erect position.

Typically, the sled body is configured, sized and made out of a material such that the sled body curls into a roll, up to substantially midway between the sled first and second longitudinal ends, when the sled body is attached to the user body by the shoulder releasable attachment means; the foot releasable attachment means is unattached to the user body, leaving the sled second longitudinal end free to curl up towards the sled first longitudinal end, and; the user body is in a substantially erect position.

Typically, the sled body is configured, sized and made out of a material such that the sled body curls into a roll, up to substantially the buttocks region, when the sled body is attached to the user body by the shoulder releasable attachment means; the foot releasable attachment means is unattached to the user body, leaving the sled second longitudinal end free to curl up towards the sled first longitudinal end, and; the user body is in a substantially erect position; whereby when the sled body is curled up into a roll, the sled body allows relatively free movement of the legs of the user body.

Conveniently, the sled body is configured and sized so as to allow free movement of the shoulders when attached to the user body. Typically, the sled body is configured and sized so as not to contact the rear portion of the shoulders when attached to the user body.

Conveniently, the body lateral edges are recessed towards each other adjacent the sled first longitudinal end so as to define an auxiliary body section and a main body section, the auxiliary body section having a width smaller then that of the main body section.

Typically, each of the body lateral edges about the transition between the main and auxiliary body sections has a substantially concave and arcuate configuration. Conveniently, the main body section has a substantially rectangular configuration.

Typically, the sled body defines corner sections at the intersections of its peripheral edges, the corner sections having a substantially rounded configuration.

Conveniently, the shoulder releasable attachment means includes a pair of shoulder straps each extending from the sled body for attachment to the user body respectively substantially adjacent a corresponding shoulder thereof. Typically, each of the shoulder straps is configured, positioned and sized so as to extend from the sled body at least partially over the trapezius region, at least partially across the pectoral region, at least partially across a corresponding one of the armpits and back towards the sled body. Conveniently, at least one of the shoulder straps is provided with a shoulder strap length adjustment means for allowing adjustment of its length.

Typically, both the shoulder straps are made out of a common shoulder strip, the sled body being provided with a pair of first shoulder strip apertures positioned substantially symmetrically relative to the longitudinal axis and substantially adjacent the body first longitudinal end, the sled body being also provided with a pair of second shoulder strip apertures positioned substantially symmetrically relative to the longitudinal axis and intermediate the body first and second longitudinal ends; the shoulder strip defining a pair of shoulder strip ends, a shoulder strip segment substantially adjacent each of the shoulder strip ends is secured to the sled body adjacent a corresponding one of the second shoulder strip apertures before extending from the body contacting surface through the corresponding one of the second shoulder strip apertures to the sliding surface; each shoulder strip segment then bends around an adjacent lateral peripheral edge before forming a shoulder encircling loop, each shoulder strip segment then bends back around the body first longitudinal end to the sliding surface before extending through a corresponding one of the first shoulder strip apertures towards a length adjustment loop wherein it merges with the symmetrically opposed shoulder strip segment.

Conveniently, the pair of first shoulder strip apertures and the shoulder strip are configured and sized so as to create a frictional force therebetween for releasably locking the length adjustment loop in a predetermined configuration. Typically, the foot releasable attachment means includes a pair of foot straps extending from the sled body for attachment respectively to a corresponding one of the feet. Conveniently, each of the foot straps defines a corresponding pair of foot strap ends, the foot strap ends being provided with foot strap releasable attachment means for allowing releasable attachment therebetween.

Typically, the foot strap releasable attachment means includes cooperating strips of miniature hook and loop fibers positioned adjacent corresponding pairs of foot strap ends. Conveniently, the sled body includes two sets of two spaced apart pairs of foot strap receiving slots, the two sets of foot receiving slots being substantially symmetrically disposed relative to the longitudinal axis. Advantages of the present invention include that the proposed body sled is adapted to be easily attached and adjusted by kids and also intended to provide a novel sporting goods item for winter sports. The proposed body sled is intended to be worn by the intended user so as to facilitate ascension of the hill. The sled device does not require the use of a hand to pull the device up the hill. Also, the proposed sled device is made out of relatively light material so as to facilitate climbing back up the hill.

Still furthermore, the proposed device is designed so as to provide for a proper gliding surface when being used for sliding down the hill while inherently folding or rolling back to a more compact configuration when not being used so as to again facilitate transportation thereof by reducing interference with the limbs of the intended user.

Still furthermore, the proposed device being adapted to be worn by the user reduces the risks of having the user fall off the device during use or having the user inadvertently drop the device while climbing the hill. Consequently, the proposed device significantly reduces the risks of having the sled travel down the slope unattended possibly causing damage to property, injury to bystanders and damage to the sled.

Still furthermore, the proposed device is designed so as to be relatively easily maneuverable by shifting the weight of the user and by movement of the users' limbs. Also, the proposed device is designed so as to be manufacturable using conventional forms of manufacturing with few components so as to provide a device that will be economically feasible, long lasting and relatively trouble free in operation.

### BREIF DESCRIPTION OF THE DRAWINGS

An embodiment of the present invention will now be disclosed, by way of example, in reference to the following drawings in which:

FIG. 1, in an elevational view, illustrates a sled body part of a wearable sled in accordance with an embodiment of the present invention;

FIG. 2, in a partial perspective view with sections taken out, illustrates a wearable sled in accordance with an embodiment of the present invention;

FIG. 3, in a partial perspective view with sections taken out, illustrates ankle attachment straps extending from a corresponding portion of a sled body, one of the straps being shown in an open configuration while the other is shown in a closed configuration;

FIG. 4, in a front schematic perspective view, illustrates a wearable sled in accordance with an embodiment of the present invention, the sled being worn by an intended user and in a rolled configuration;

FIG. 5, in a schematic rear perspective view, illustrates a sled in accordance with an embodiment of the present invention, the sled being shown worn by an intended user and in a rolled configuration;

FIG. 6, in a schematic perspective view, illustrates a sled in accordance with an embodiment of the present invention, the sled being shown worn by an intended user and in a deployed configuration as the intended user is shown sliding therewith;

FIG. 7, in a partial perspective view with sections taken out, illustrates a length adjustment loop of a shoulder strap part of a wearable sled in accordance with an embodiment of the present invention.

### DETAILED DESCRIPTION

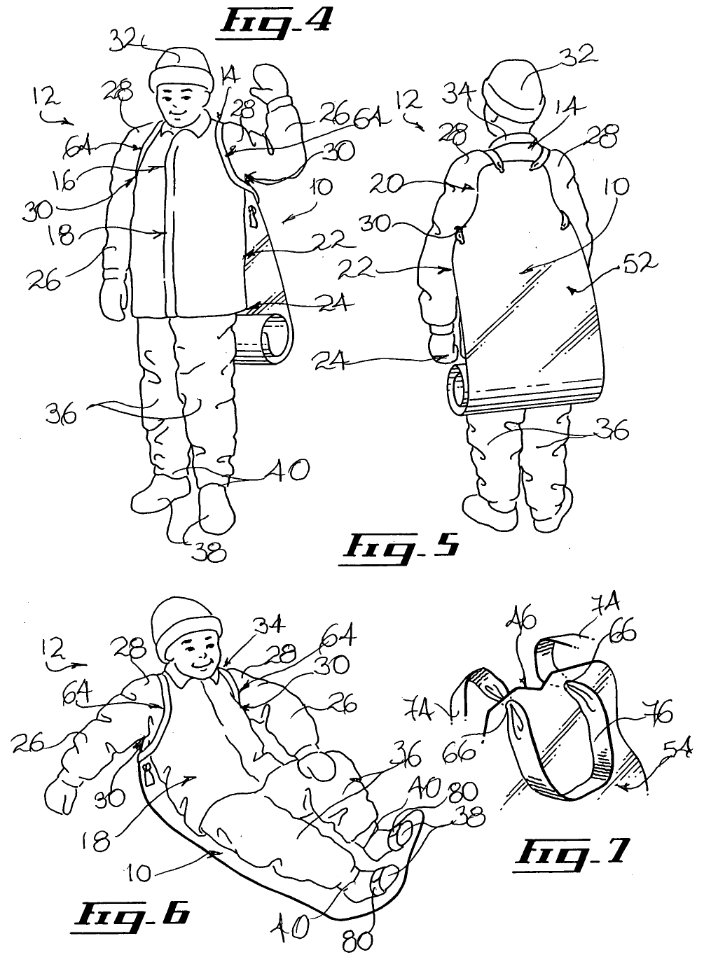

Referring to FIGS. 4 through 6, there is shown a wearable sled 10 in accordance with an embodiment of the present invention being worn by an intended user 12. FIGS. 4 and 5 illustrate the sled 10 in a so-called rolled configuration wherein it can be ergonomically transported by the intended user 12 to a suitable sliding location whereas FIG. 6 illustrates the sled 10 in a so-called deployed configuration wherein it can be used for sliding down a suitable sliding surface such as a slope covered with snow.

The user 12 is shown having a user body defining a trunk having a trunk upper end. The trunk upper end includes a trapezius region 14. The trunk also defines a trunk front side including a pectoral region 16 and an abdominal region 18. The trunk also defines a trunk rear side including a scapulae region 20, a lumbar region 22 and a buttocks region 24.

The user body also has a pair of arms 26 connected to the trunk by a corresponding pair of shoulders 28. The arms 26 and the trunk together define a corresponding pair of armpits 30. The user body further includes a head 32 connected to the trunk by a neck 34. The user body also has a pair of legs 36 connected to the trunk by a corresponding pair of hips and a pair of feet 38 connected to the legs 36 by a corresponding pair of ankles 40.

It should be understood that although the intended user 12 is shown in FIGS. 4 through 6 as having specific morphologic features, the wearable sled 10 could be used by individuals having other types of morphologic features without departing from the scope of the present invention.

As illustrated more specifically in FIG. 2, the wearable sled 10 includes a sled body 42 made out of a substantially thin and flexible sled body material. The sled body 42 has a substantially elongated configuration defining a longitudinal axis 44, a sled first longitudinal end 46, an opposed sled second longitudinal end 48 and a pair of substantially longitudinally extending body lateral edges 50. The sled body 42 has a sliding surface 52 shown in FIG. 5 for slidably contacting a suitable slippery surface and a user contacting surface 54 for contacting the user body.

The wearable sled 10 also includes a shoulder releasable attachment means extending from the sled body 42 substantially adjacent the sled first longitudinal end 46 for releasably attaching the sled body 42 to the user body substantially adjacent the shoulders 28 thereof. The wearable sled 10 further has a foot releasable attachment means extending from the sled body 42 substantially adjacent the sled second longitudinal end 48 for releasably attaching the sled body 42 to the user body substantially adjacent the feet 38 thereof.

As illustrated more specifically in FIG. 6, the sled body 42 is configured and sized for extending substantially across the waist of the user body from the base of the neck region 34 to the feet 30 when the sled body 42 is in a deployed configuration with the shoulder and foot releasable attachment means attached to the user body. Typically, the sled body 42 is configured and sized for allowing bending of the user body about the abdominal region 18 and dorsiflexion of the feet 38 about the ankles 40.

The sled body 42 is typically made out of a substantially flat strip of sled body material. The sled body material typically includes any suitable polymeric resin. In one embodiment of the invention, the polymeric resin includes a high density polyethylene. Typically, although by no means exclusively, the strip thickness has a value of approximately 40 thousands of an inch.

As illustrated more specifically in FIGS. 4 and 5, the sled body 42 is typically designed so as to resiliently curl up at least partially into a rolled configuration when in a relaxed state deprived of external forces exerted thereon other than gravity. Typically, the sled body 42 is configured, sized and made out of material such that the sled body 42 curls up into a roll when the sled body 42 is attached to the user body by shoulder releasable attachment means, the shoulder releasable attachment means is unattached to the user body and the user body is in substantially erect position.

In such a position illustrated in FIGS. 4 and 5, the sled second longitudinal end 48 is allowed to curl up towards the sled first longitudinal end 46. Typically, the sled body 42 is configured, sized and made of a material such that the sled body 42 curls into a roll up to substantially midway between the sled first and second longitudinal ends 46, 48 or up substantially to the buttocks region 24 of the user body. Accordingly, when the sled body 42 is in the rolled configuration shown in FIGS. 4 and 5, the sled body 42 allows relatively free movement of the legs 36 of the intended user 12.

The sled body 42 is also preferably configured and sized so as to allow free movement of the shoulders 28 when worn by the user 12. As illustrated more specifically in FIG. 5, the sled body 42 is typically configured and sized so as not to contact the rear portion of the shoulders 28 when attached to the user body.

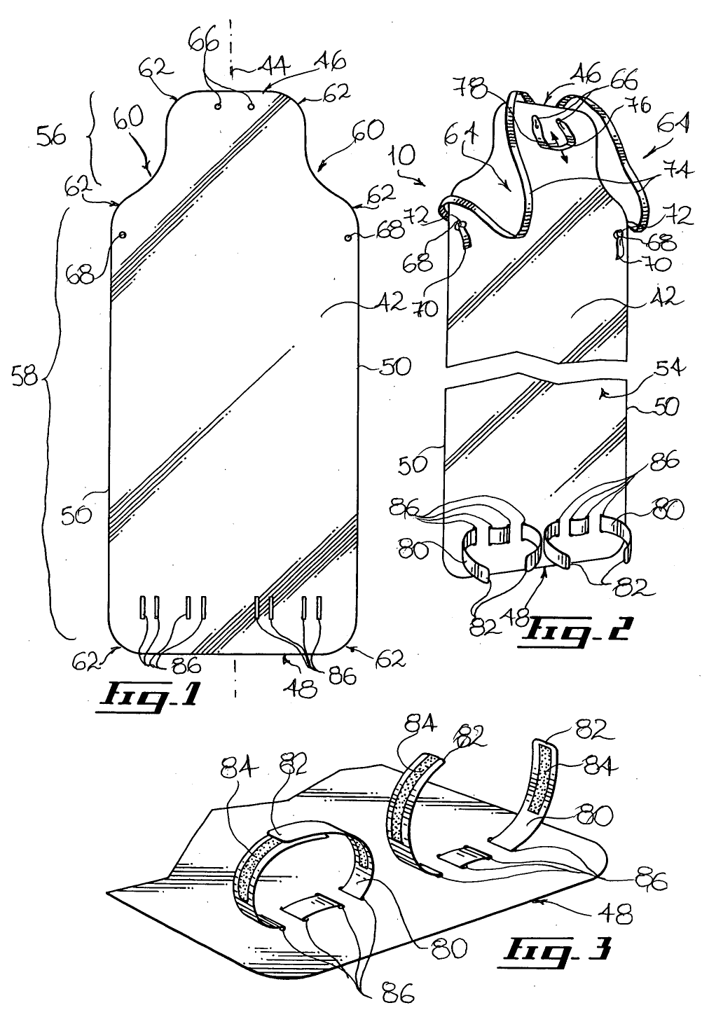

As illustrated more specifically in FIG. 1, the body lateral edges 50 are recessed towards each other adjacent the sled first longitudinal end 46 so as to define an auxiliary body section 56 and a contiguous main body section 58. The auxiliary body section 56 has a width smaller than that of the main body section 58.

The body lateral edges 50 about the transition 60 between the main and auxiliary body sections 58, 56 typically has a substantially concave and arcuate configuration. The main body section 58 typically has a substantially rectangular configuration. The sled body 42 defines corner sections 62 at the intersection of its peripheral edges. The corner sections 62 typically have a substantially rounded configuration.

As illustrated more specifically in FIGS. 2, 4, and 6, the shoulder releasable attachment means typically includes a pair of shoulder straps 64 each extending from the sled body 42 for attachment to the user body respectively substantially adjacent a corresponding shoulder 28 thereof. Each of the shoulder straps 64 is configured, positioned and sized so as to extend from the sled body 42 at least partially over the trapezius region 14, at least partially across the pectoral region 16, at least partially a corresponding one of the armpits 30 and back towards the sled body 42.

At least one and preferably both shoulder straps 64 are provided with a shoulder strap length adjustment means for allowing adjustment of its length and, hence, customisation thereof according to the morphologic features of a given user.

As illustrated more specifically in FIG. 2, both shoulder straps 64 are typically made out of a common shoulder strip. As illustrated more specifically in FIG. 1, the sled body 42 is typically provided with a pair of first shoulder strip apertures 66 positioned substantially symmetrically relative to the longitudinal axis 44 and intermediate the body first and second longitudinal ends 46, 48. Typically, the second should strip apertures 68 are located substantially adjacent the transition 60 between the body main and auxiliary sections 58, 56.

The shoulder strip defines a pair of shoulder strip ends 70. The shoulder strip substantially adjacent each of the shoulder strip ends 70 is secured to the sled body 42 adjacent a corresponding one of the second shoulder strip apertures 68 by a suitable shoulder strip attachment means. The shoulder strip attachment means may take any suitable form such as knots 72 formed in the shoulder strip.

The shoulder strip adjacent each shoulder strip ends 70 extends from the body contacting surface 54 through a corresponding one of the shoulder strip apertures 68 to the sliding surface 52. Each shoulder strip section then bends around an adjacent lateral peripheral edge 50 thereof for forming a shoulder encircling loop 74.

Each shoulder strip segment then bends back around the body first longitudinal end 46 to the sliding surface 52 before extending through a corresponding one of the first shoulder strip apertures 66 towards a length adjustment loop 76 wherein it merges with the symmetrically opposed shoulder strip segment.

As illustrated more specifically in FIG. 7, the pair of first shoulder strip apertures 66 and the shoulder strip are configured and sized so that the shoulder strip is squeezed through the first shoulder strip apertures 66 hence creating a frictional force therebetween. The frictional force between the peripheral edge of the first shoulder strip apertures 66 and the shoulder strip acts as a length adjustment releasable locking means for releasably locking the length adjustment loop 76 in a predetermined configuration.

By adjusting the size of the length adjustment loops 76 according to arrows 78 in FIG. 2, the length of the shoulder encircling loop 74 is also modified. The length adjustment loop 76 is hence adapted to act as an effective shoulder strap length adjustment means for allowing adjustment of the size of the shoulder encircling loop 74.

As illustrated more specifically in FIGS. 2, 3, and 6, the foot releasable attachment means typically includes a pair of foot straps 80 extending from the sled body 42 for attachment respectively to a corresponding one of the feet 38. Each foot strap 80 defines a corresponding pair of foot strap ends 82. The foot strap ends 82 are provided with foot strap releasable attachment means for allowing releasable attachment therebetween in a foot strap closed configuration shown on the left hand side of FIG. 3.

The foot strap releasable attachment means may take any suitable form. For example, the foot strap releasable attachment means may include cooperating strips 84 of miniature hook end loop fibres (commonly sold under the trade mark VELCRO).

In use the intended user 12 first straps the shoulder straps 64 around the shoulders 28 preferably positioning the auxiliary section 56 substantially centered relative to the scapulae such as shown in FIG. 5. The design and inherent resiliency of the sled body 42 allows the body second longitudinal end 48 to resiliently curl up into the rolled configuration shown in FIGS. 4 and 5.

In the rolled configuration shown in FIGS. 4 and 5, interference between the legs 36 and the sled body 42 is reduced hence facilitating transportation of the wearable sled to a suitable sliding location such as adjacent the top of a snow covered hill. The smaller width of the auxiliary section 56 reduces interference between the sled body 42 and the shoulders 28 so as to further facilitate transportation of the wearable sled 10 by allowing relatively free swinging of the arms 26.

Once the intended user 12 has reached a suitable starting location, the intended user 12 merely needs to deploy the sled body 42 and attach the foot straps 80 around the feet 38. The intended user 12 may then assume a suitable sliding position such as shown in FIG. 6 wherein the body of the intended user 12 may be bent about the abdominal region 18 and the feet 38 dorsiflexed about the ankles 40. By shifting body weight and moving the trunk and/or the legs 36, the wearable sled 10 may be ergonomically steered as the intended user 12 slides down a hill or other suitable sliding surface.

When not in use, the wearable sled 10 may be easily rolled up so as to minimise storage space. The length adjustment loops 76 and the strips 84 of miniature hook and loop fibre allow for quick customisation of respectively the shoulder and foot releasable attachment means to the morphologic features of the intended user 12 through a set of quick and ergonomic steps.

The embodiments of the invention in which an exclusive privilege or property is claimed are defined as follows:

1. A sled for allowing an intended user to slide on a slippery surface, said user having a user body defining a trunk, said trunk having a trunk upper end including a trapezius region, a trunk front side including a pectoral region and an abdominal region, a trunk rear side including a scapulae region, a lumbar region and a buttocks region, said user body also having a pair of arms connected to said trunk by a corresponding pair of shoulders, said arms and said trunk together defining a corresponding pair of armpits, said user body further having a head connected to said trunk by a neck, a pair of legs connected to said trunk by a corresponding pair of hips and a pair of feet connected to said legs by a corresponding pair of feet; said sled comprising:
a sled body made out of a substantially thin and flexible sled body material, said sled body having a substantially elongated configuration defining a longitudinal axis, a sled first longitudinal end, an opposed sled second longitudinal end and a pair of substantially longitudinally extending body lateral edges; said sled body having a sliding surface for slidably contacting said slippery surface and a user contacting surface for contacting said user body;
a shoulder releasable attachment means extending from said sled body substantially adjacent said sled first longitudinal end for releasably attaching said sled body to said user body substantially adjacent said shoulders thereof;
an foot releasable attachment means extending from said sled body substantially adjacent said sled second longitudinal end for releasably attaching said sled body to said user body substantially adjacent said feet thereof;
said sled body being configured and sized for extending substantially across the width of said user body from the base of said neck region to said feet when said sled body is in a deployed configuration with said shoulder and foot releasable attachment means attached to said user body.

2. A sled as recited in claim 1 wherein said sled body is made out of a substantially flat strip of sled body material.

3. A sled as recited in claim 2 wherein said sled body material is a polymeric resin.

4. A sled as recited in claim 3 wherein said polymeric resin includes high density polyethylene.

5. A sled as recited in claim 4 wherein said strip has a strip thickness of approximately 40 thousands of an inch.

6. A sled as recited in claim 1 wherein said sled body resiliently curls up at least partially into a rolled configuration when in a relaxed state deprived of external forces exerted thereon other then gravity.

7. A sled as recited in claim 6 wherein said sled body is configured, sized and made out of a material such that said sled body curls up into a roll when
said sled body is attached to said user body by said shoulder releasable attachment means;
said foot releasable attachment means is unattached to said user body, leaving said sled second longitudinal end free to curl up towards said sled first longitudinal end, and;
said user body is in a substantially erect position.

8. A sled as recited in claim 6 wherein said sled body is configured, sized and made out of a material such that said sled body curls into a roll, up to substantially midway between said sled first and second longitudinal ends, when
said sled body is attached to said user body by said shoulder releasable attachment means;
said foot releasable attachment means is unattached to said user body, leaving said sled second longitudinal end free to curl up towards said sled first longitudinal end, and;
said user body is in a substantially erect position.

9. A sled as recited in claim 6 wherein said sled body is configured, sized and made out of a material such that said sled body curls into a roll, up to substantially said buttocks region, when
said sled body is attached to said user body by said shoulder releasable attachment means;
said foot releasable attachment means is unattached to said user body, leaving said sled second longitudinal end free to curl up towards said sled first longitudinal end, and;
said user body is in a substantially erect position;
whereby when said sled body is curled up into a roll, said sled body allows relatively free movement of said legs of said user body.

10. A sled as recited in claim 1 wherein said sled body is configured and sized so as to allow free movement of said shoulders when attached to the user body.

11. A sled as recited in claim 1 wherein said sled body is configured and sized so as not to contact the rear portion of said shoulders when attached to the user body.

12. A sled as recited in claim 1 wherein said body lateral edges are recessed towards each other adjacent said sled first longitudinal end so as to define an auxiliary body section and a main body section, said auxiliary body section having a width smaller then that of said main body section.

13. A sled as recited in claim 12 wherein each of said body lateral edges about the transition between said main and auxiliary body sections has a substantially concave and arcuate configuration.

14. A sled as recited in claim 12 wherein said main body section has a substantially rectangular configuration.

15. A sled as recited in claim 14 wherein said sled body defines corner sections at the intersections of its peripheral edges, said corner sections having a substantially rounded configuration.

16. A sled as recited in claim 1 wherein said shoulder releasable attachment means includes a pair of shoulder straps each extending from said sled body for attachment to said user body respectively substantially adjacent a corresponding shoulder thereof.

17. A sled as recited in claim 16 wherein each of said shoulder straps is configured, positioned and sized so as to extend from the sled body at least partially over said trapezius region, at least partially across said pectoral region, at least partially across a corresponding one of said armpits and back towards said sled body.

18. A sled as recited in claim 16 wherein at least one of said shoulder straps is provided with a shoulder strap length adjustment means for allowing adjustment of its length.

19. A sled as recited in claim 16 wherein both said shoulder straps are made out of a common shoulder strip, said sled body being provided with a pair of first shoulder strip apertures positioned substantially symmetrically relative to said longitudinal axis and substantially adjacent said body first longitudinal end, said sled body being also provided with a pair of second shoulder strip apertures positioned substantially symmetrically relative to said longitudinal axis and intermediate said body first and second longitudinal ends; said shoulder strip defining a pair of shoulder strip ends, a shoulder strip segment substantially adjacent each of said shoulder strip ends is secured to said sled body adjacent a corresponding one of said second shoulder strip apertures before extending from said body contacting surface through said corresponding one of said second shoulder strip apertures to said sliding surface; each shoulder strip segment then bends around an adjacent lateral peripheral edge before forming a shoulder encircling loop, each shoulder strip segment then bends back around said body first longitudinal end to said sliding surface before extending through a corresponding one of said first shoulder strip apertures towards a length adjustment loop wherein it merges with the symmetrically opposed shoulder strip segment.

20. A sled as recited in claim 19 wherein said pair of first shoulder strip apertures and said shoulder strip are configured and sized so as to create a frictional force therebetween for releasably locking said length adjustment loop in a predetermined configuration.

21. A sled as recited in claim 1 wherein said foot releasable attachment means includes a pair of foot straps extending from said sled body for attachment respectively to a corresponding one of said feet.

22. A sled as recited in claim 21 wherein each of said foot straps defines a corresponding pair of foot strap ends, said foot strap ends being provided with foot strap releasable attachment means for allowing releasable attachment therebetween.

23. A sled as recited in claim 22 wherein said foot strap releasable attachment means includes cooperating strips of miniature hook and loop fibers positioned adjacent corresponding pairs of foot strap ends.

24. A sled as recited in claim 21 wherein said sled body includes two sets of two spaced apart pairs of foot strap receiving slots, said two sets of foot receiving slots being substantially symmetrically disposed relative to said longitudinal axis.
